(19) United States
(12) Patent Application Publication
(10) Pub. No.: US 2022/0046040 A1
(43) Pub. Date: Feb. 10, 2022

(54) DETECTION DEVICE, DETECTION METHOD, AND DETECTION PROGRAM

(71) Applicant: NIPPON TELEGRAPH AND TELEPHONE CORPORATION, Tokyo (JP)

(72) Inventors: Kazunori KAMIYA, Musashino-shi, Tokyo (JP); Hiroshi KURAKAMI, Musashino-shi, Tokyo (JP)

(73) Assignee: NIPPON TELEGRAPH AND TELEPHONE CORPORATION, Tokyo (JP)

(21) Appl. No.: 17/276,487

(22) PCT Filed: Sep. 18, 2019
(86) PCT No.: PCT/JP2019/036551

§ 371 Date: Mar. 16, 2021

(30) Foreign Application Priority Data
Oct. 12, 2018 (JP) 2018-193385

(51) Int. Cl. H04L 29/06

(52) U.S. Cl. CPC H04L 63/1425; H04L 63/1491; H04L 2463/141; H04L 63/1458

(57) ABSTRACT

A detection apparatus includes processing circuitry configured to store attack information including detection time, attack attribute, and communication destination of a DDoS attack, and extract, from a collection of the attack information, a combination of the attack information according to the detection time, the attack attribute, and the communication destination as a coincident attack, an intermittent attack, or an identical target attack.

### TECHNICAL FIELD

The present invention relates to a detection apparatus, a detection method, and a detection program.

### BACKGROUND ART

Detection techniques of a distributed denial of service (DDoS) attack have been known. For example, BackScatter (refer to Non Patent Literature 1) for detecting transmission source assumption attacks, HoneyPot for detecting reflection attacks (refer to Non Patent Literature 2), xFlow for detecting volume attacks (refer to Non Patent Literature 3) have been known.

In recent years, the multi-vector DDoS attack combining multiple DDoS attacks has become a threat.

### CITATION LIST

### Non Patent Literature

Non Patent Literature 1: “Worldwide Detection of Denial of Service (DoS) Attack”, [online] August, 2001, [Searched on Sep. 7, 2018], Internet <URL: https://www.caida.org/publications/presentations/usenix0108/dos/dos.pdf
Non Patent Literature 2: “AmpPot: Monitoring and Defending Against Amplification DDoS Attacks”, [online], [Searched on Sep. 7, 2018], Internet <URL: https://christian-rossow.de/publications/amppot-raid2015.pdf>
Non Patent Literature 3: “The Latest Trend for Measures against DDoS”, [online], November, 2017, NTT Communications Corporation, [Searched on Sep. 7, 2018], Internet <URL: https://www.nic.ad.jp/ja/materials/iw/2017/proceedings/s06/s6-nishizuka.pdf>

### SUMMARY OF THE INVENTION

### Technical Problem

However, according to the related-art techniques of detecting the single DDoS attack, it has been difficult to detect the multi-vector DDoS attack. As a result, the actual condition of the multi-vector DDoS attack cannot be grasped, and it has been difficult to properly protect against the attack.

In light of the foregoing, an object of the present invention is to detect the multi-vector DDoS attack.

### Means for Solving the Problem

In order to solve the problems described above and achieve an object, a detection apparatus according to the present invention includes: a storage unit configured to store attack information including detection time, attack attribute, and communication destination of a DDoS attack; and an extraction unit configured to extract, from a collection of the attack information, a combination of the attack information according to the detection time, the attack attribute, and the communication destination as a coincident attack, an intermittent attack, or an identical target attack.

### Effects of the Invention

According to the present invention, the multi-vector DDoS attack can be detected.

### BRIEF DESCRIPTION OF DRAWINGS

FIG. 1 is a diagram for explaining summary of processing of a detection apparatus according to a present embodiment.

FIG. 2 are diagrams for explaining the summary of the processing of the detection apparatus according to the present embodiment.

FIG. 3 is a schematic diagram illustrating a schematic configuration of the detection apparatus according to the present embodiment.

FIG. 4 is a table illustrating a data configuration of single DDoS attack detection information.

FIG. 5 is a table for explaining processing of an extraction unit.

FIG. 6 is a table for explaining processing of the extraction unit.

FIG. 7 is a flowchart illustrating a detection processing procedure.

FIG. 8 is a flowchart illustrating a detection processing procedure.

FIG. 9 is a flowchart illustrating a detection processing procedure.

FIG. 10 is a diagram illustrating an example of a computer that executes a detection program.

### DESCRIPTION OF EMBODIMENTS

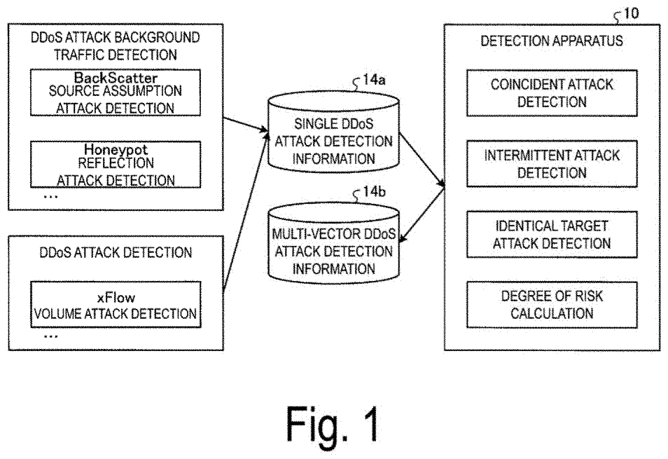

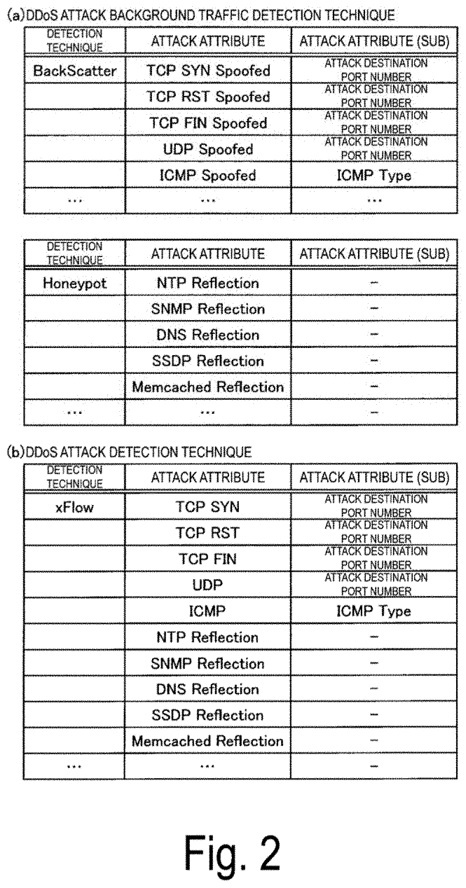

Hereinafter, embodiments of the present disclosure will be described in detail with reference to the drawings. Note that the present disclosure is not limited by the embodiments. In the description of the drawings, the identical parts are denoted by the identical reference signs.

[Summary of Processing] FIGS. 1 and 2 are diagrams for explaining summary of processing of a detection apparatus according to a present embodiment. The detection apparatus according to the present embodiment uses information on detected single DDoS attacks to detect the multi-vector DDoS attack.

The single DDoS attack detection information 14a illustrated in FIG. 1 is a collection of information on single DDoS attacks detected by various detection techniques. As illustrated in FIG. 1, the techniques of detecting the single DDoS attack include DDoS attack background traffic detection and DDoS attack detection.

The DDoS attack background traffic detection is a technique of detecting traffic behind the DDoS attack, such as spam mail, and examples of such technique include BackScatter and Honeypot. The BackScatter detects the transmission source assumption attack that assumes the transmission source to prompt transmission of a return mail. The Honeypot detects the reflection attack that reflects a response to a request to a target server.

The DDoS attack detection is a technique of detecting the DDoS attack itself, and includes xFlow, for example. The xFlow detects the volume attack that sends a large volume of traffic to bring the target server or the like to stop.

As illustrated in FIG. 2, the different detection techniques detect attacks having different attack attributes. For example, as illustrated in FIG. 2(a), examples of the attack attributes of attacks detected by BackScatter include TCP SYN Spoofed, TCP RST Spoofed, TCP FIN Spoofed, UDP Spoofed, and the like. Note that an attacked port number is assigned to each attack attribute.

Examples of the attack attributes of attacks detected by Honeypt include NTP Reflection, SNMP Reflection, DNS Reflection, and the like.

As illustrated in FIG. 2(b), examples of the attack attributes of attacks detected by the) (Flow include TCP SYN, TCP RST, TCP FIN, and the like. Note that an attacked port number is assigned to each attack attribute.

The detection apparatus 10 according to the present embodiment combines multiple pieces of attack information on the single DDoS attacks detected by various detection techniques such as those described above according to detection time, attack attribute, communication destination (attack destination), and the like, thereby detecting the occurrence of the multi-vector DDoS attack.

For example, the detection apparatus 10 detects the occurrence of one of a coincident attack, an intermittent attack, or an identical target attack. The coincident attack is the multi-vector DDoS attack in which attacks having different attributes simultaneously occur against the identical communication destination. The intermittent attack is the multi-vector DDoS attack in which attacks having different attributes intermittently occur against the identical communication destination. The identical target attack is the multi-vector DDoS attack in which attacks having different attributes against the identical target such as the identical Web application occur.

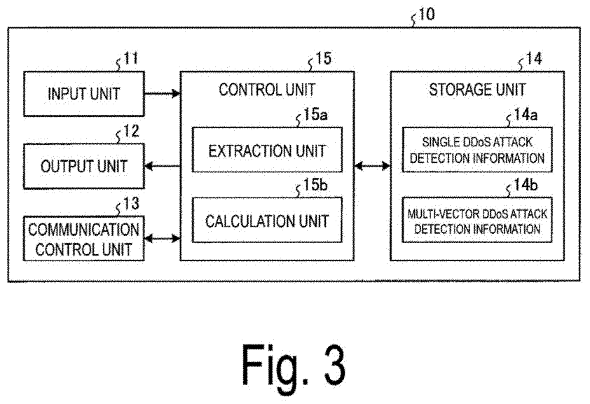

Furthermore, the detection apparatus 10 calculates the degree of risk of the detected multi-vector DDoS attack using attack scale, duration, and the like of each piece of attack information. The detection apparatus accumulates the actual condition of the detected multi-vector DDoS attack as multi-vector DDoS attack detection information 14b.

[Configuration of Detection Apparatus] FIG. 3 is a schematic diagram illustrating a schematic configuration of the detection apparatus according to the present embodiment. As illustrated as an example in FIG. 3, the detection apparatus 10 is implemented by a general-purpose computer such as a personal computer and includes an input unit 11, an output unit 12, a communication control unit 13, a storage unit 14, and a control unit 15.

The input unit 11 is implemented by using an input device such as a keyboard and a mouse, and inputs various kinds of command information for starting processing to the control unit 15 in response to an input operation of an operator. The output unit 12 is implemented by a display apparatus such as a liquid crystal display or a print apparatus such as a printer.

The communication control unit 13 is implemented by a network interface card (NIC) or the like and controls communication between the control unit 15 and an external apparatus via an electric communication line such as a local area network (LAN) or the Internet.

The storage unit 14 is implemented by a random access memory (RAM), a semiconductor memory element such as a flash memory, or a storage apparatus such as a hard disk and an optical disc, and stores a batch generated by detection processing described later. Note that the storage unit 14 may be configured to communicate with the control unit 15 via the communication control unit 13.

According to the present embodiment, the storage unit 14 stores the single DDoS attack detection information 14a and the multi-vector DDoS attack detection information 14b. Each record in the single DDoS attack detection information 14a is attack information including detection time, attack attribute, and communication destination of the single DDoS attack.

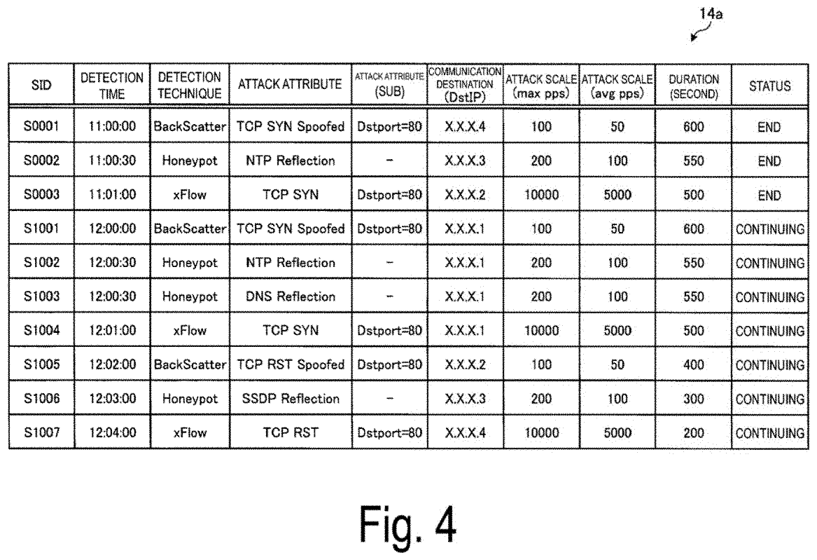

Specifically, FIG. 4 is a diagram illustrating a data configuration of the single DDoS attack detection information 14a. As illustrated in FIG. 4, each piece of attack information of the single DDoS attack detection information 14a includes SID that identifies the DDoS attack, detection time, detection technique, attack attribute, communication destination, attack scale, duration, and status. FIG. 4 illustrates attack information on terminated single DDoS attacks with terminated status and attack information on continuing single DDoS attacks with continuing status.

The attack scale refers to the DDoS attack scale estimated according to the thickness or the like of the link used for the attack, and identifies average value (avg pps) and estimated maximum value (max pps). The duration indicates a period from the detection time to the end time in the case of the terminated status, and a period from the detection time to the current time in the case of the continuing status.

The multi-vector DDoS attack detection information 14b will be described later.

The control unit 15 is implemented by using a Central Processing Unit (CPU) or the like, and executes a processing program stored in a memory. Accordingly, the control unit 15 functions as an extraction unit 15a and a calculation unit 15b as illustrated in FIG. 3. Note that these functional units may be implemented in different pieces of hardware.

The extraction unit 15a extracts, from the collection of attack information, the combination of attack information in the single DDoS attack detection information 14a according to detection time, attack attribute, and communication destination, as the coincident attack, the intermittent attack, or the identical target attack.

Specifically, the extraction unit 15a extracts, from the single DDoS attack detection information 14a, which is the collection of attack information, the combination of attack information having different attack attributes and a difference between detection times within a predetermined period against the identical communication destination, as the coincident attack.

Note that the extraction unit 15a does not combine attack information having different detection techniques and the identical attack attribute. The extraction unit combines attack information having the identical detection technique and different attack attributes.

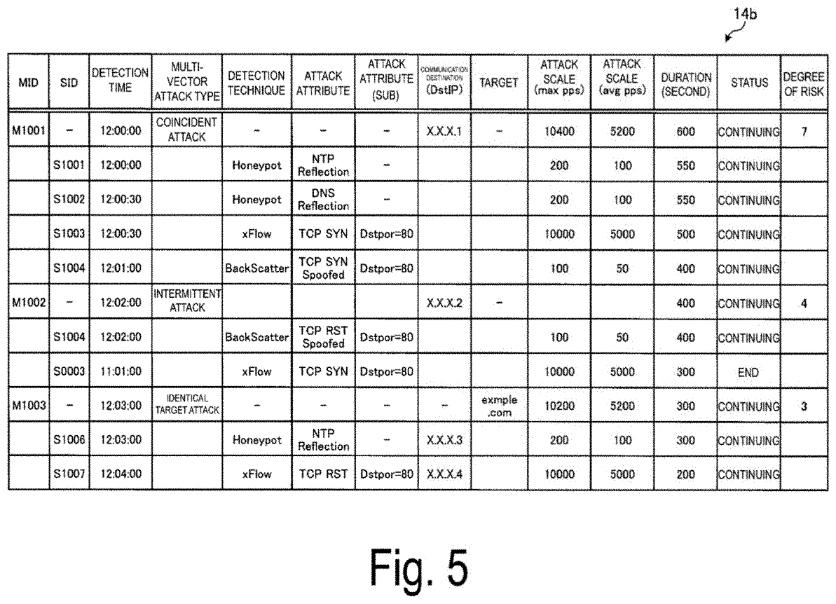

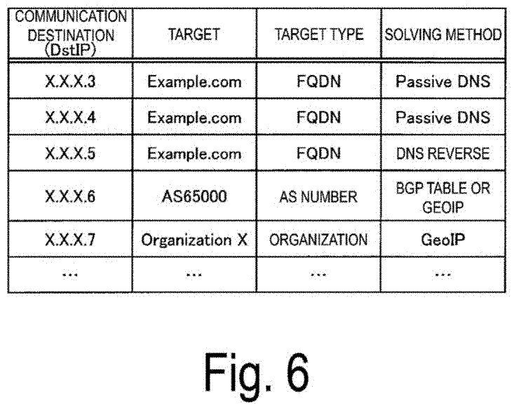

FIG. 5 and FIG. 6 are diagrams for explaining processing of the extraction unit 15a. For example, since the attack information having the SID of S1001 to S1004 in FIG. 4 is attack information with different attack attributes having the identical communication destination and the distance between detection times within, for example, 30 seconds, the extraction unit 15a extracts the attack information as the coincident attack.

The extraction unit 15a accumulates the extracted multi-vector DDoS attack in the multi-vector DDoS attack detection information 14b, as illustrated in FIG. 5. The multi-vector DDoS attack detection information 14b illustrated in FIG. 5 includes information on the multi-vector DDoS attack in addition to the attack information on the single DDoS attacks that constitute the multi-vector DDoS attack (see FIG. 4).

In the example illustrated in FIG. 5, the information on the multi-vector DDoS attack includes MID, multi-vector attack type, communication destination, target, attack scale, duration, status, and degree of risk. The MID refers to information that identifies the multi-vector DDoS attack, and the multi-vector attack type refers to one of the coincident attack, the intermittent attack, or the identical target attack. The target will be described later.

The attack scale of the multi-vector DDoS attack is represented by a sum of the attack scales in the attack information on attacks constituting the multi-vector DDoS attack. The duration of the multi-vector DDoS attack is a period from the earliest detection time among detection times of each piece of attack information to the current time or the end time of the multi-vector DDoS attack, at which all single DDoS attacks have been terminated. For example, the calculation unit 15b described below calculates attack scale, duration, and degree of risk described later, and includes them in the multi-vector DDoS attack detection information 14b.

The extraction unit 15a extracts, from the collection of attack information in the single DDoS attack detection information 14a, the combination of the attack information having different attack attributes and a difference between detection times more than a predetermined period against the identical communication destination, as the intermittent attack. For example, the extraction unit 15a extracts, from the attack information illustrated in FIG. 4, the attack information having continuing status and SID of S1004 and the attack information having the identical communication destination, terminated status, different attack attribute, and SID of S0003, and determines these attacks as the intermittent attacks.

Note that for the intermittent attack, the duration of the multi-vector DDoS attack is the longest duration of the durations of attack information on attacks constituting the multi-vector DDoS attack.

The extraction unit 15a also extracts, from the collection of attack information in the single DDoS attack detection information 14a, the combination of attack information having different attack attributes against communication destinations belonging to the identical target, as the identical target attack. For example, even when the communication destinations are different, but the attack information are estimated to belong to the identical target such as the identical Web application, the extraction unit 15a may detect the identical target attack.

FIG. 6 illustrates a technique of estimating that different communication destinations belong to the identical target. For example, the extraction unit 15a uses a technique called Passive DNS or DNS reverse lookup to identify a fully qualified domain name (FQDN) of the communication destination, and estimate that the communication destinations of the identical FQDN belong to the identical target. Alternatively, the extraction unit 15a uses a border gateway protocol (BGP) table or GeoIP to identify an autonomous system (AS) number of the communication destination, and estimate that communication destinations having the identical AS number belong to the identical target. Alternatively, the extraction unit 15a uses GeoIP to identify an organization of the communication destination, and estimates that communication destinations belonging to the identical organization belong to the identical target.

In this case, the extraction unit 15a extracts the combination of attack information having different attack attributes against the communication destinations estimated to belong to the identical target as the identical target attack. In addition, as illustrated in FIG. 5, the extraction unit 15a accumulates the extracted combination of attack information and the target in the multi-vector DDoS attack detection information 14b.

A description is given with reference to FIG. 3 again. The calculation unit 15b uses detection technique, attack scale, or duration in the attack information in the single DDoS attack detection information 14a to calculate the degree of risk of the extracted combination of attack information.

For example, the calculation unit 15b calculates, for each extracted multi-vector DDoS attack, as described above, the sum of the attack scales in the attack information on attacks constituting the multi-vector DDoS attack as the attack scale of the multi-vector DDoS attack. The calculation unit 15b also calculates, as the duration of the multi-vector DDoS attack, the period from the earliest detection time of the detection times in each piece of attack information to the current time or the time at which all of the single DDoS attacks have been terminated, i.e., the multi-vector DDoS attack end time.

Then, the calculation unit 15b calculates following items A through D, for example, for each extracted multi-vector DDoS attack, and calculates a sum of values of each of the items A through D as the degree of risk of the multi-vector DDoS attack.

A=number of detection techniques/all detection techniques

B=attack scale/presumed maximum attack scale

C=duration/presumed maximum duration

D=M_D1 (in the case of coincident attack), M_D2 (in the case of intermittent attack), M_D3 (in the case of identical target attack)

Here, each of the values M_D1, M_D2, and M_D3 in the item D is a value previously set according to the expected degree of risk for each attack type. The values in Items A, B, and C are values normalized by respective predetermined maximum values (M_A, M_B, M_C). Furthermore, a sum of the maximum value of M_A, M_B, and M_C and the maximum value of M_D1, M_D2, and M_D3 is previously set to N (for example, 10).

By calculating the degree of risk by the calculation unit 15b in this manner, the degree of risk of the extracted multi-vector DDoS attack is quantified with the value normalized by N according to the number of detection techniques, attack scale, attack interval, attack type, and the like.

As illustrated in FIG. 5, the calculation unit 15b accumulates attack scale, duration, and degree of risk of the calculated multi-vector DDoS attack in the multi-vector DDoS attack detection information 14b.

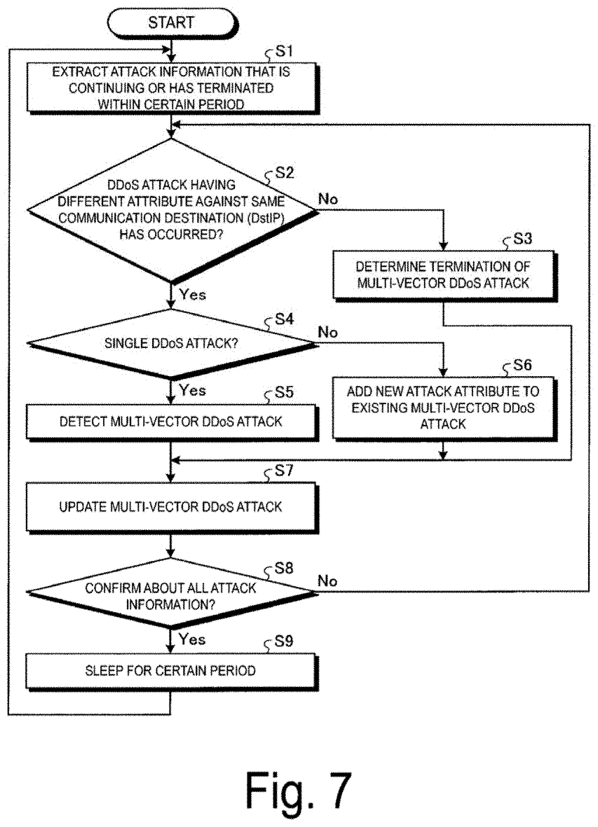

Note that the definition of the degree of risk is not limited to the above. For example, the calculation unit 15b may use some of the above-described items A to D to define the degree of risk and calculate its value.

[Detection Processing] Next, detection processing executed by the detection apparatus 10 according to the present embodiment will be described with reference to FIGS. 7 to 9. FIGS. 7 to 9 each are a flowchart illustrating a detection processing procedure. For example, the flowchart illustrated in each of the figures starts at a timing when the user makes an input to instruct the start of the processing.

First, FIG. 7 illustrates the detection processing procedure for the coincident attack. First, the extraction unit 15a extracts, from the single DDoS attack detection information 14a, attack information that is continuing or has terminated within a certain period (Step S1).

The extraction unit 15a selects the continuing attack information and confirms whether or not attack information having a different attack attribute against the identical communication destination (DstIP) with respect to the selected continuing attack information is present, that is, the coincident attack has occurred (Step S2).

In the processing in Step S2, in the case where the applicable attack information is absent (Step S2, No), the extraction unit 15a determines that the multi-vector DDoS attack has terminated (Step S3), and the processing proceeds to Step S7.

On the contrary, in the processing in Step S2, in the case where the applicable attack information is present (Step S2, Yes), the extraction unit 15a confirms whether or not the continuing attack information is the single DDoS attack (Step S4). When the continuing attack information is the single DDoS attack (Step S4, Yes), then extraction unit 15a determines to detect the multi-vector DDoS attack constituted of the two DDoS attacks (Step S5) and moves the processing to Step S7.

When the continuing attack information is not the single DDoS attack (Step S4, No), extraction unit 15a determines to detect new attack information added to the existing multi-vector DDoS attack including the continuing attack information (Step S6) and moves the processing to Step S7.

In the processing in Step S7, the extraction unit 15a updates the multi-vector DDoS attack detection information 14b. Thereafter, the extraction unit 15a confirms whether or not the above processing has been performed on all continuing attack information (Step S8). When the above processing has not been performed on all continuing attack information (Step S8, No), the extraction unit 15a returns the processing to Step S2. On the contrary, when the above processing has been performed on all continuing attack information (Steps S8, Yes), the extraction unit 15a terminates the series of detection processing and returns the processing to Step S1 after sleep for a certain period (Step S9).

This causes the extraction unit 15a to detect the coincident attack in the multi-vector DDoS attack, and accumulates the detected information in the multi-vector DDoS attack detection information 14b.

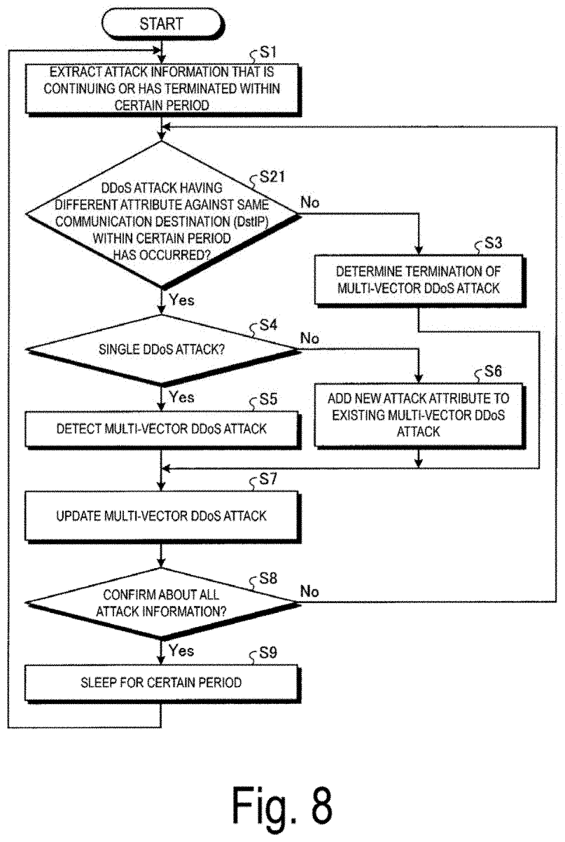

FIG. 8 illustrates a detection processing procedure for the intermittent attack. The processing in FIG. 8 differs from the processing in FIG. 7 in that the processing in Step S21 is performed in place of processing in Step S2. Since the other processing is similar to that in FIG. 7, description thereof will be omitted.

In the processing in Step S21, the extraction unit 15a selects the continuing attack information and confirms whether or not attack information having a different attack attribute against the identical communication destination (DstIP) within a certain period with respect to the selected continuing attack information is present, that is, the intermittent attack has occurred.

In this manner, the extraction unit 15a detects the intermittent attack in the multi-vector DDoS attack, and stores the detected information in the multi-vector DDoS attack detection information 14b.

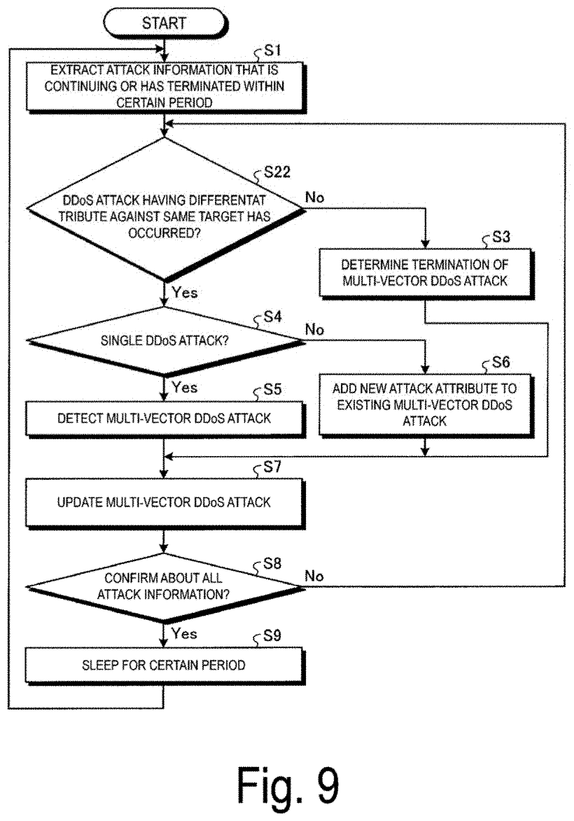

FIG. 9 illustrates a detection processing procedure for the identical target attack. The processing in FIG. 9 differs from the processing in FIG. 7 in that the processing in Step S22 is performed in place of processing in Step S2. Since the other processing is similar to that in FIG. 7, description thereof will be omitted.

In the processing in Step S22, the extraction unit 15a selects the continuing attack information and confirms whether or not attack information having a different attack attribute against communication destinations (DstIP) belonging to the identical target with respect to the selected continuing attack information is present, that is, the identical target attack has occurred.

This causes the extraction unit 15a to detect the identical target attack in the multi-vector DDoS attack, and accumulates the detected information in the multi-vector DDoS attack detection information 14b.

As described above, in the detection apparatus 10 according to the present embodiment, the storage unit 14 stores the attack information including detection time, attack attribute, and communication destination of the DDoS attack. The extraction unit 15a extracts, from the collection of attack information, the combination of attack information according to detection time, attack attribute, and communication destination, as the coincident attack, the intermittent attack, or the identical target attack.

For example, the extraction unit 15a extracts, from the collection of attack information, the combination of attack information having different attack attributes and a difference between detection times within a predetermined period against the identical communication destination, as the coincident attack. The extraction unit 15a extracts, from the collection of attack information, the combination of the attack information having different attack attributes and a difference between detection times more than a predetermined period against the identical communication destination, as the intermittent attack. The extraction unit 15a also extracts, from the collection of attack information, the combination of attack information having different attack attributes against communication destinations belonging to the identical target, as the identical target attack.

The detection apparatus 10 can use attack information on the detected single DDoS attacks to detect the multi-vector DDoS attack. Thus, the actual condition of the multi-vector DDoS attack can be grasped to properly protect against the attack.

The attack information in the storage unit 14 further includes attack scale and duration, and the calculation unit 15b uses detection technique, attack scale, or duration in the attack information to calculate the degree of risk of the extracted combination of attack information. As a result, the detection apparatus 10 can quantify the degree of risk of multi-vector DDoS attacks according to the number of detection techniques, attack scale, attack interval, attack type, and the like. Thus, the actual condition of the multi-vector DDoS attack can be grasped more specifically to protect against the attack more properly.

[Program] It is also possible to create a program in which processing executed by the detection apparatus 10 according to the embodiment described above is described in a computer-executable language. As an embodiment, the detection apparatus 10 can be implemented by a detection program executing the detection processing being installed as packaged software or online software in a desired computer. For example, an information processing apparatus executes the detection program, and thus, the information processing apparatus can function as the detection apparatus 10. The information processing device referred here includes a desktop or notebook personal computer. In addition, a mobile communication terminal such as a smartphone, a mobile phone, or a personal handyphone system (PHS), further a slate apparatus such as a personal digital assistant (PDA), and the like are also included in the scope of the information processing apparatus. In addition, the functions of the detection apparatus 10 may be mounted in a cloud server.

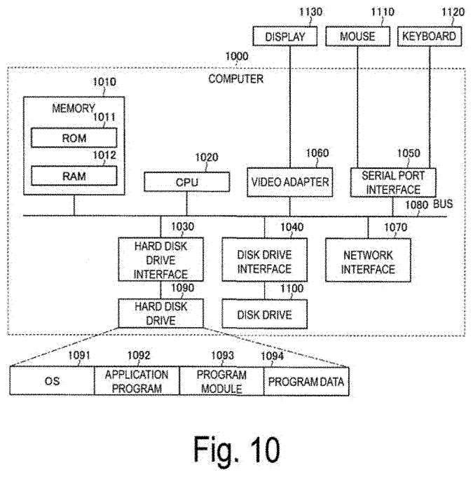

FIG. 10 is a diagram illustrating an example of the computer that executes the detection program. A computer 1000 includes, for example, a memory 1010, a CPU 1020, a hard disk drive interface 1030, a disk drive interface 1040, a serial port interface 1050, a video adapter 1060, and a network interface 1070. These components are connected by a bus 1080.

The memory 1010 includes a read only memory (ROM) 1011 and a RAM 1012. The ROM 1011 stores, for example, a boot program such as a Basic Input Output System (BIOS). The hard disk drive interface 1030 is connected to the hard disk drive 1031. The disk drive interface 1040 is connected to a disk drive 1041. A detachable storage medium such as a magnetic disk or an optical disc, for example, is inserted into the disk drive 1041. A mouse 1051 and a keyboard 1052, for example, are connected to the serial port interface 1050. A display 1061, for example, is connected to the video adapter 1060.

Here, the hard disk drive 1031 stores, for example, an OS 1091, an application program 1092, a program module 1093, and program data 1094. The respective pieces of information described in the aforementioned embodiments are stored in, for example, the hard disk drive 1031 and the memory 1010.

Further, the detection program, for example, is stored in the hard disk drive 1031 as the program module 1093 in which commands to be executed by the computer 1000 have been described. Specifically, the program module 1093 in which each processing executed by the detection apparatus 10 described in the aforementioned embodiment is described is stored in the hard disk drive 1031.

Further, data to be used in information processing according to the detection program is stored, for example, in the hard disk drive 1031 as the program data 1094. Then, the CPU 1020 reads the program module 1093 and the program data 1094 stored in the hard disk drive 1031 as needed in the RAM 1012 and executes each of the aforementioned procedures.

The program module 1093 or the program data 1094 related to the detection program is not limited to being stored in the hard disk drive 1031. For example, the program module 1093 or the program data 1094 may be stored on a detachable storage medium and read by the CPU 1020 via the disk drive 1041 or the like. Alternatively, the program module 1093 or the program data 1094 related to the detection program may be stored in another computer connected via a network such as a Local Area Network (LAN) or a Wide Area Network (WAN) and read by the CPU 1020 via the network interface 1070.

Although the embodiments to which the disclosure made by the present inventors is applied have been described above, the present disclosure is not limited by the description and the drawings as a part of the present disclosure according to the embodiments. In other words, all of other embodiments, examples, operation technologies, and the like made by those skilled in the art based on the present embodiment are within the scope of the disclosure.

### REFERENCE SIGNS LIST

10 Detection apparatus
11 Input unit
12 Output unit
13 Communication control unit
14 Storage unit
14a Single DDoS attack detection information
14b Multi-vector DDoS attack detection information
15 Control unit
15a Extraction unit
15b Calculation unit

1. A detection apparatus comprising:
processing circuitry configured to:
store attack information including detection time, attack attribute, and communication destination of a DDoS attack; and
extract, from a collection of the attack information, a combination of the attack information according to the detection time, the attack attribute, and the communication destination as a coincident attack, an intermittent attack, or an identical target attack.

2. The detection apparatus according to claim 1, wherein the processing circuitry is further configured to extract, from the collection of the attack information, a combination of attack information having different attack attributes and a difference between detection times not more than a predetermined period against the identical communication destination, as the coincident attack.

3. The detection apparatus according to claim 1, wherein the processing circuitry is further configured to extract, from the collection of the attack information, a combination of attack information having different attack attributes and a difference between detection times more than a predetermined period against the identical communication destination, as the intermittent attack.

4. The detection apparatus according to claim 1, wherein the processing circuitry is further configured to extract, from the collection of the attack information, a combination of attack information having different attack attributes against communication destinations belonging to the identical target as the identical target attack.

5. The detection apparatus according to claim 1, wherein
the attack information further includes detection technique, attack scale, and duration, and
the processing circuitry is further configured to use the detection technique, the attack scale, or the duration in the attack information to calculate a degree of risk of the extracted combination of attack information.

6. A detection method comprising:
referring to a storage configured to store attack information including detection time, attack attribute, and communication destination of a DDoS attack to extract, from a collection of the attack information, a combination of the attack information according to the detection time, the attack attribute, and the communication destination as a coincident attack, an intermittent attack, or an identical target attack, by processing circuitry.

7. A non-transitory computer-readable recording medium storing therein a detection program that causes a computer to execute a process comprising:
referring to a storage configured to store attack information including detection time, attack attribute, and communication destination of a DDoS attack to extract, from a collection of the attack information, a combination of the attack information according to the detection time, the attack attribute, and the communication destination as a coincident attack, an intermittent attack, or an identical target attack.
